(19) United States
(12) Patent Application Publication
(10) Pub. No.: US 2026/0328593 A1
(43) Pub. Date: Oct. 22, 2026

(54) EDDY CURRENT SENSOR

(71) Applicant: BOURNS, INC., Riverside, CA (US)

(72) Inventor: Christian Seene, Aying (DE)

(21) Appl. No.: 19/652,985

(22) Filed: Apr. 20, 2026

(30) Foreign Application Priority Data
Apr. 21, 2025 (DE) 10 2025 115 365.5

(51) Int. Cl. G01D 5/20; B62D 15/02; G01B 7/00; G01B 7/14

(52) U.S. Cl. CPC G01D 5/202; B62D 15/021; G01B 7/003; G01B 7/14

(57) ABSTRACT

An eddy current sensor including a first and a second eddy current sensor partner. The sensor partners are configured to generate an electromagnetic measurement field dependent on the relative position. The sensor includes an evaluation circuit configured to determine the relative position based on the field, wherein one sensor partner is configured to generate the measurement field and the other partner is configured to generate an electromagnetic induction field based on the measurement field. The sensor partner generating the induction field has, in a transverse direction perpendicular to the direction of movement and perpendicular to a distance between the sensor partners, a smaller extent than the eddy current sensor partner generating the measurement field, characterized by correction partner arranged in a fixed position relative to the first sensor partner for generating an electromagnetic correction field for correcting a transverse displacement between the sensor partners transverse to the direction of movement.

### RELATED APPLICATIONS

This application claims the benefit of German Patent Application No. DE 10 2025 115 365.5, filed Apr. 21, 2025, the entire content of which is hereby incorporated by reference.

### BACKGROUND OF THE INVENTION

The present invention relates to an eddy current sensor, to a tie rod sensor comprising the eddy current sensor, and to a method for detecting a relative position.

An eddy current sensor is known from DE 196 31 438 A1.

From DE 10 2022 114 508 A1 it is known to increase a measurement signal in an eddy current sensor by means of an additional target.

It is an object of the invention to improve the known system.

### BRIEF SUMMARY OF THE INVENTION

Starting from an eddy current sensor for detecting a relative position in a direction of movement, comprising a first eddy current sensor partner and a second eddy current sensor partner that is positionable relative to the first eddy current sensor partner in the relative position to be detected, wherein the eddy current sensor partners are configured to generate an electromagnetic measurement field dependent on the relative position, and comprising an evaluation circuit configured to determine the relative position based on the electromagnetic measurement field, wherein one of the eddy current sensor partners is configured to generate the electromagnetic measurement field and the other eddy current sensor partner is configured to generate an electromagnetic induction field based on the electromagnetic measurement field, and wherein the eddy current sensor partner generating the electromagnetic induction field has, in a transverse direction perpendicular to the direction of movement and perpendicular to a distance between the eddy current sensor partners, a smaller lateral extent than the eddy current sensor partner generating the electromagnetic measurement field, the invention provides that a correction partner is arranged in a fixed position relative to the first eddy current sensor partner at a predetermined distance for generating an electromagnetic correction field for correcting a transverse displacement between the eddy current sensor partners transverse to the direction of movement.

The eddy current sensor mentioned at the outset is based on the consideration that, when the relative position is evaluated exclusively in the direction of movement, transverse movements, such as those caused by mechanical tolerances, deformations, or bending of components such as a tie rod—also referred to as a steering rod—are not detected. Such transverse displacements can asymmetrically influence the electromagnetic measurement field and lead to distorted measurement results, since they cannot readily be distinguished from the actual relative movements of interest. In particular, in highly dynamic applications or those with limited mechanical degrees of freedom, this can result in unacceptable measurement errors.

The eddy current sensor mentioned above addresses this by the idea of arranging a correction partner at a predetermined distance from one of the two eddy current sensor partners. The correction partner is in a known geometric relationship with one of the eddy current sensor partners and is integrated into the eddy current sensor in such a way that additional information can be obtained via this distance, enabling consideration or correction of a transverse displacement between the eddy current sensor partners transverse to the direction of movement. Since, in the case of a transverse displacement, the distances between both eddy current sensor partners are affected differently, the known geometry between the correction partner and the associated eddy current sensor partner enables a distinction between relative movement in the direction of movement and displacement transverse thereto.

In this way, a transverse displacement between the eddy current sensor partners can be suppressed from the outset, identified for error detection, or compensated in order to improve the reliability of the detected relative position, such that a significantly more robust and reliable detection of the relative position in the direction of movement becomes possible. The invention is particularly suitable for applications in which the eddy current sensor partners form part of mechanically compliant or bendable structures in which position changes do not occur exclusively along an idealized direction of movement. A typical example is the detection of a wheel steering angle via the position of a tie rod in a vehicle, where bending effects due to the weight of the vehicle or assembly tolerances can lead to transverse movements that would result in significant measurement errors without the correction capability according to the invention.

Eddy current sensors are known that are operated with multiple eddy current sensor partners, in which in particular multiple field-influencing elements are provided, for example to increase signal strength. In such arrangements, the field-influencing elements typically have a larger lateral extent than the field-generating element, so that the field-influencing elements act over a substantially homogeneous region of the electromagnetic measurement field and contribute to the measured quantity in the same direction. This leads in particular to an additive superposition of the signal components.

In contrast, the present invention is based on the finding that a different operating behavior can be achieved when the lateral extent of the eddy current sensor partner generating the electromagnetic induction field is selected to be smaller, in a direction orthogonal to the direction of movement and to a connection direction between the eddy current sensor partners, than the corresponding extent of the eddy current sensor partner generating the electromagnetic measurement field. In such an arrangement, the eddy current sensor partners are not located in a substantially homogeneous field region, but in regions of differing field strength, such that a relative displacement transverse to the direction of movement results in a counteracting change in the electromagnetic coupling of the eddy current sensor partners. As a result, disturbing transverse movements do not lead to a same-direction change of the signal, but are at least partially compensated, whereby the robustness of the position determination is significantly improved.

The terms “eddy current sensor partner” denote complementary functional units of the eddy current sensor that jointly participate in the generation and field-dependent influence of the electromagnetic source field. One of the eddy current sensor partners is to be understood as an excitation element, i.e. an excitation coil, for generating an electromagnetic source field, while the other eddy current sensor partner is to be understood as a reflector element configured to generate an induction field based on the electromagnetic source field, said induction field being directed opposite to the electromagnetic source field and forming at least part of the electromagnetic measurement field. The assignment of roles is unambiguous: if one eddy current sensor partner is interpreted as an excitation element, the other must be interpreted as a reflector element, and vice versa.

The determination of the relative position to be detected from the electromagnetic measurement field comprising the electromagnetic induction field can generally be carried out in two ways. On the one hand, the relative position to be detected can be determined from a change in electrical properties of the excitation coil itself caused by the electromagnetic measurement field. These property changes can be determined by analyzing the impedance of the excitation coil, in particular its AC resistance, its inductance, and/or the phase relationship between current and voltage. This so-called damping principle is based on the fact that the electromagnetic source field generated by the excitation coil induces eddy currents in the reflector, which in turn generate the electromagnetic induction field in the form of a counter-field, which influences the current consumption and the impedance of the excitation coil. In this variant, the relative position is determined by evaluating the resulting impedance change. On the other hand, the relative position to be detected can be determined based on the so-called transformer principle. In this case, at least one receiving coil is provided in addition to the excitation coil, in which a voltage is induced by the electromagnetic induction field originating from the reflector. This voltage depends in a characteristic manner on the spatial relationship between the excitation coil, the reflector, and the receiving coil. The relative position can then be determined from the amplitude, phase, or frequency dependence of the induced voltage.

In a further development of the specified eddy current sensor, the first eddy current sensor partner comprises a reflector and the second eddy current sensor partner comprises an excitation coil for generating an electromagnetic source field, wherein the reflector is configured to generate, based on the electromagnetic source field, an electromagnetic induction field contained in the electromagnetic measurement field. In this way, when the correction partner is arranged in a fixed position relative to the reflector, a direct geometric relationship between these two elements can be established, such that a change in the distance between the reflector-correction partner system and the excitation coil caused by a transverse displacement can be clearly interpreted by comparing the electromagnetic induction field and the electromagnetic correction field. This enables a robust differentiation between relative movements in the measurement direction and transverse movements, since the latter affect the respective measured quantities in a characteristic manner due to the fixed internal geometry of the reflector and the correction partner.

In a particular embodiment of the transformer principle explained above, multiple receiving coils having a periodic geometry, in particular a sine and cosine geometry, are used, which are arranged phase-shifted relative to one another. The signals received by these coils can be related to one another, such that fine detection of the relative position is possible by means of phase-based interpolation. This method allows, in a manner analogous to the vernier or interpolation principle, a significant refinement of position determination within a geometric base grid and thus contributes to an increase in measurement accuracy and resolution of the sensor.

In a particular further development of the specified eddy current sensor, the correction partner is a reflector and is configured to generate an electromagnetic induction field that is directed opposite to the electromagnetic induction field of the first eddy current sensor partner. In this way, the correction partner can be integrated into the existing sensor system without additional electrical actuation or signal processing, which leads to reduced space requirements, particularly in applications with limited installation space or integration constraints. Since no dedicated supply lines or signal connections are required, compact and mechanically robust sensor units can be realized in which the functionality for transverse displacement correction is achieved purely by structural means.

In a preferred further development of the specified eddy current sensor, the excitation coil is designed as a flat coil extending in a coil plane defined by the direction of movement. In this way, a high sensitivity to distance changes perpendicular to the coil plane is achieved, whereby in particular relative movements of the reflector transverse to the direction of movement can be detected with high resolution. In addition, the flat design enables space-saving integration into compact sensor arrangements. Furthermore, the two-dimensional structure of the flat coil allows simple expansion to multi-channel systems, for example by arranging multiple flat coils next to one another or in a differential configuration, whereby the detection and compensation of transverse displacements can be further improved.

In a particularly preferred further development of the specified eddy current sensor, the coil plane is oriented perpendicular to an imaginary connecting line between the first eddy current sensor partner and the correction partner. In this way, a clear geometric separation between the main detection direction of the sensor and the relative position of the field-effective elements is achieved, whereby transverse displacements can be differentiated in a characteristic manner and made accessible to structural correction. In addition, mutual interference of the fields is minimized, which improves signal quality and simplifies evaluation. The orthogonal arrangement also supports a compact and calibratable integration of all sensor components with high measurement accuracy and stability, particularly in mechanically demanding environments.

In a further development of the specified eddy current sensor, the second eddy current sensor partner divides a space into a first half-space and a second half-space opposite the first half-space, wherein the first eddy current sensor partner is arranged in the first half-space and the correction partner is arranged in the second half-space. In this way, a symmetrical sensor architecture is created in which the second eddy current sensor partner serves as a central reference point, while the field-influencing elements are arranged on both sides thereof in a defined geometry. This enables differential evaluation in which relative movements of the first eddy current sensor partner and of the correction partner have opposite effects on the measured quantity, so that in particular lateral deviations or asymmetric influences can be detected or compensated. This development is particularly effective in the case of an arrangement in which the second eddy current sensor partner is an excitation coil extending in a coil plane defined by the direction of movement and arranged perpendicular to a connecting line between the first eddy current sensor partner and the correction partner, both of which are formed as reflectors. In this configuration, the attenuating influence of the correction partner counteracts an asymmetry in the field coupling of the first eddy current sensor partner caused by transverse displacement, whereby transverse errors can be structurally suppressed without requiring evaluation by the evaluation circuit.

In a further development of the specified eddy current sensor, the first eddy current sensor partner is arranged in the first half-space and the correction partner is arranged at the same position with respect to the direction of movement. In this way, the symmetry of the field-influencing elements relative to the direction of movement is increased, whereby the influence of transverse displacements on the electromagnetic measurement field is further reduced. Due to the aligned positioning of the reflector and the correction partner along the direction of movement, lateral deviations affect the respective field coupling in an approximately opposing manner, so that transverse errors can be more clearly identified and reduced in their effect by appropriate evaluation. This development thus represents a refinement of the concept of structural transverse displacement compensation and improves the robustness of the position evaluation with respect to lateral tolerances or bending effects.

In a further development of the specified eddy current sensor, the first eddy current sensor partner in the first half-space and the correction partner are of identical design. In this way, field symmetry is further improved at a structural level, such that transverse displacements can be largely or completely eliminated from the sensor signal with a corresponding arrangement, in particular with symmetrical distances of the two partners from the excitation coil. The identical design leads to disturbing effects caused by lateral movements acting in opposite directions and with equal magnitude on the field influence, whereby they cancel out in differential evaluation. As a result, the relative position in the direction of movement can be detected with particularly high accuracy and robustness against interference—even in systems with pronounced mechanical compliance or high thermal loads.

According to a further aspect of the invention, a tie rod sensor for detecting a position of a tie rod of a vehicle in a transverse direction perpendicular to the driving direction comprises one of the specified eddy current sensors, wherein one eddy current sensor partner is connectable in a fixed manner to a chassis of the vehicle and the other eddy current sensor partner is connectable in a fixed manner to the tie rod of the vehicle.

The specified tie rod sensor is based on the consideration that a direct position measurement at the tie rod is particularly sensitive to tolerances and dynamic deformations, such as those occurring in particular due to bending loads during vehicle steering movements. Such transverse deformations lead to undesired changes in distance between sensor partners, which in conventional sensor systems that are based on a single target result in significant losses in accuracy. In addition, known solutions often require the integration of space-consuming sensor units (“sensor towers”) on the tie rod or the indirect determination of the steering angle via other components such as the steering wheel, which increases cost and complexity.

The specified tie rod sensor addresses this by the idea of using two eddy current sensor partners having a defined geometric relationship to one another, between which the excitation element is arranged in a central position. Due to this symmetrical arrangement, a transverse displacement of the tie rod caused by bending affects both field-influencing elements in the same direction but in an opposing manner, such that the interference effects compensate each other under appropriate evaluation. The sensor configuration according to the invention is designed such that the relative transverse position of the tie rod can be detected robustly and reliably even in the presence of mechanical deformation of the system.

In this way, the wheel steering angle can be detected directly at the tie rod without having to rely on complex or expensive steering angle sensor systems at the steering wheel. Integration into the chassis and/or the tie rod can be achieved in a space-saving manner and without movable cable connections, whereby, in addition to reducing manufacturing costs, robustness against environmental influences such as vibration, temperature, or contamination is increased. The omission of separate sensor assemblies at other locations in the vehicle simplifies the system architecture and opens up new possibilities for modular steering systems, in particular in applications with steer-by-wire technology.

In a further development of the specified steering angle sensor, the electromagnetic source field has a magnetic flux density whose equivalent current direction vector is arranged in a plane oriented radially with respect to the direction of movement.

According to a further aspect of the invention, a method for detecting a relative position in a direction of movement by means of one of the specified eddy current sensors comprises the steps of generating an electromagnetic source field with one of the eddy current sensor partners, generating an electromagnetic measurement field comprising an electromagnetic induction field generated based on the electromagnetic source field with the other eddy current sensor partner, generating an electromagnetic correction field with the correction partner for correcting a transverse displacement in the driving direction between the eddy current sensor partners transverse to the direction of movement, and determining the relative position based on the electromagnetic measurement field and the electromagnetic correction field.

The specified method is based on the consideration that the evaluation of an electromagnetic measurement field formed solely by an electromagnetic induction field—as is customary in conventional eddy current sensor methods with only one reflector—is particularly susceptible to disturbances caused by transverse movements, temperature fluctuations, and mechanical deformations. Especially in mechanically flexible structures, such as those occurring for example due to the weight of the vehicle at the tie rod in a vehicle, position changes perpendicular to the actual measurement direction can significantly affect sensor accuracy and lead to erroneous position signals.

The specified method addresses this by the idea of additionally generating a correction field that can be used in a targeted manner for the structural differentiation between relative position and transverse displacement. The generation of a correction field by a correction partner arranged in a defined geometric relationship to one of the eddy current sensor partners makes it possible to generate measurement signals that exhibit a characteristic response to transverse deviations. By the combined evaluation of the damped excitation field and the correction field, the relative position in the direction of movement can be determined with improved accuracy, since disturbance influences acting transverse to the direction of movement can either be systematically suppressed or clearly identified and computationally compensated.

In this way, a robust, adaptively evaluable measurement method is obtained, which can also be used under demanding environmental conditions. The integration of the correction field into the method logic furthermore allows the use of simplified physical models for evaluation, since structurally generated redundancy is used to make undesired influences geometrically and signal-technically separable. The method is therefore particularly suitable for safety-relevant applications in which high accuracy and fault tolerance are required together with a compact design.

According to a further aspect of the invention, a control device is configured to carry out one of the specified methods.

In a further development of the specified device, the specified device comprises a memory and a processor. The specified method is stored in the memory in the form of a computer program, and the processor is configured to execute the method when the computer program is loaded from the memory into the processor.

According to a further aspect of the invention, a computer program comprises program code means for carrying out all steps of the specified method when the computer program is executed on an electronic device or one of the specified devices.

According to a further aspect of the invention, a computer program product comprises a program code stored on a computer-readable medium which, when executed on a data processing device, performs the specified method.

### BRIEF DESCRIPTION OF THE DRAWINGS

The properties, features, and advantages of the present invention described above, as well as the manner in which they are achieved, become more readily apparent in connection with the following description of exemplary embodiments, which are explained in more detail with reference to the drawings. The figures show:

FIG. 1 a schematic representation of the principle of a vehicle dynamics control system of a vehicle,

FIG. 2 a schematic representation of the vehicle from FIG. 1 in a perspective view,

FIG. 3a a schematic representation of a conventional eddy current sensor at a tie rod of the vehicle of FIG. 2,

FIG. 3b a schematic representation of an eddy current sensor according to the invention at a tie rod of the vehicle of FIG. 2 from a first view, and

FIG. 3C the eddy current sensor from FIGS. 3A and 3B from a second view.

In the figures, identical technical elements are provided with identical reference signs and are described only once. The figures are purely schematic and in particular do not represent the actual geometric proportions.

### DETAILED DESCRIPTION

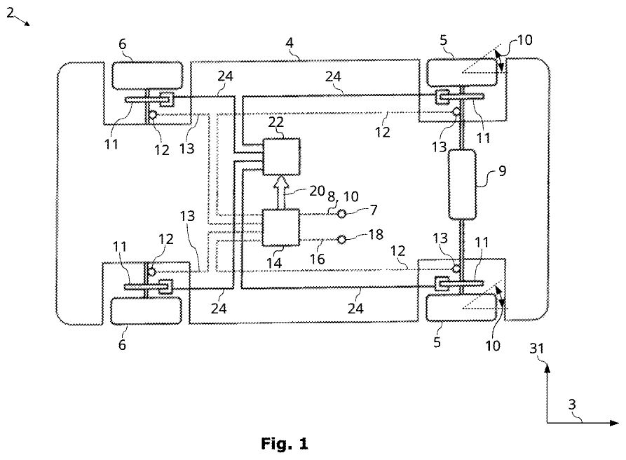

Referring to FIG. 1, a schematic representation of a vehicle 2 having a substantially known vehicle dynamics control system is shown. Details of this vehicle dynamics control system can be found in DE 10 2011 080 789 A1.

The vehicle 2 is movable in a driving direction 3 and comprises a chassis 4, also referred to as a vehicle frame, which is movably supported in the driving direction 3 by two front wheels 5 and two rear wheels 6. Each wheel 5, 6 can be braked by means of a brake, to be explained later, which is fixedly mounted on the chassis 4, in order to slow down the movement of the vehicle 2 on a road not shown in the figures.

The driving direction 3 during movement of the vehicle 2 can be controlled by the driver of the vehicle 2 by turning a steering wheel 7, which is symbolically shown in FIG. 1, into a steering angle 8. The steering wheel 7 in turn controls, based on the steering angle 8, a steering gear 9, which sets a wheel steering angle 10 of the front wheels 5 as a function of the steering angle 8. Based on the temporal change of the steering angle 8, the vehicle 2 follows a trajectory on the road defined by the driver.

During movement of the vehicle 2, it may occur, in a manner known to the skilled person, that the wheels 5, 6 lose contact with the road and deviate from the trajectory specified by the driver. In order to avoid such behavior, the vehicle 2 is equipped with the vehicle dynamics control system mentioned at the outset.

The vehicle dynamics control system comprises, at each wheel 5, 6, the aforementioned brake, which is designated in FIG. 1 with reference sign 11, as well as a wheel speed sensor 12. The wheel speed sensor 12 measures the wheel speed 13 of each wheel and transmits it to a control unit 14. The control unit 14 additionally receives inertial data 16, such as a yaw rate of the vehicle 2, from an inertial sensor 18 and calculates therefrom the actual driving direction. Subsequently, the control unit 14 checks whether the determined driving direction corresponds to the steering angle 8 specified by the driver or to the wheel steering angle 10. In the event of a deviation, the control unit 14 outputs a control signal 20 to an actuator 22, which actuates the brakes 11 individually with suitable actuator signals 24 in order to correct the driving direction 3 of the vehicle.

In such control systems, the steering angle 8 is usually used as a measure for the driving direction 3 specified by the driver. However, in modern vehicle systems with active steering systems, variable steering ratios, or mechanical compliance in the steering system, a significant deviation can occur between the steering angle 8 and the wheel steering angle 10 actually set at the wheels 5. Therefore, in safety-critical or highly automated applications, it is necessary to directly detect the wheel steering angle 10 and to incorporate it as the relevant control variable into the vehicle dynamics control system. Only in this way can it be ensured that the actual response of the vehicle 2 corresponds to the driver's intention or the system command, and that targeted corrections can be performed in the event of deviations.

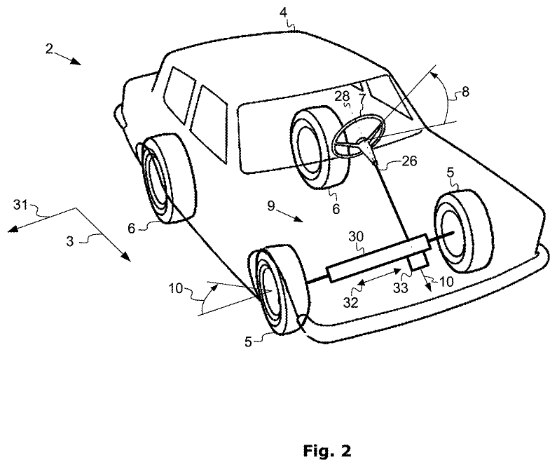

Referring to FIG. 2, the steering mechanism in the vehicle 2 is explained schematically. In order not to unnecessarily complicate the following explanations, many technical elements, such as active steering elements or the like, have been omitted. Details for understanding a steering mechanism can be found, for example, in DE 10 2005 007 307 A1.

When the driver rotates the steering wheel 7 into the steering angle 8, the steering wheel 7 rotates a steering column 26 about a rotational axis 28, which in turn moves a tie rod 30 to steer the front wheels. The rotational angle of the steering column 26 about the rotational axis 28 corresponds to the steering angle 8, such that, by measuring the rotational angle of the steering column 26, the steering angle 8 of the steering wheel 7 is known.

The tie rod 30 is mechanically connected to the front wheels 5 and converts the rotational movement of the steering column 26 into a translational movement, by means of which the wheel steering angles 10 of the front wheels 5 are changed. The actual steering angle 10 of a front wheel 5 thus results directly from the instantaneous position of the tie rod 30 relative to the chassis 4 of the vehicle 2. This position describes the lateral displacement of the tie rod 30 in a transverse direction 31 perpendicular to the driving direction 3 and is in a fixed geometric relationship with the wheel steering angle 10.

Based on this relationship, the wheel steering angle 10 can be determined by detecting the relative position 32 of the tie rod 30 with respect to the chassis 4. For this purpose, a position sensor 33 is used, which will be discussed in more detail at a later point. Given known kinematics of the components of the steering system of the vehicle 2, the currently applied wheel steering angle 10 can be precisely calculated or directly derived from the relative position 32. Such a method enables highly accurate, direct detection of the wheel steering angle 10 independently of mechanical tolerances, play, or variable steering ratios. A prerequisite for this is that the wheel steering angle 10 is detected with high precision.

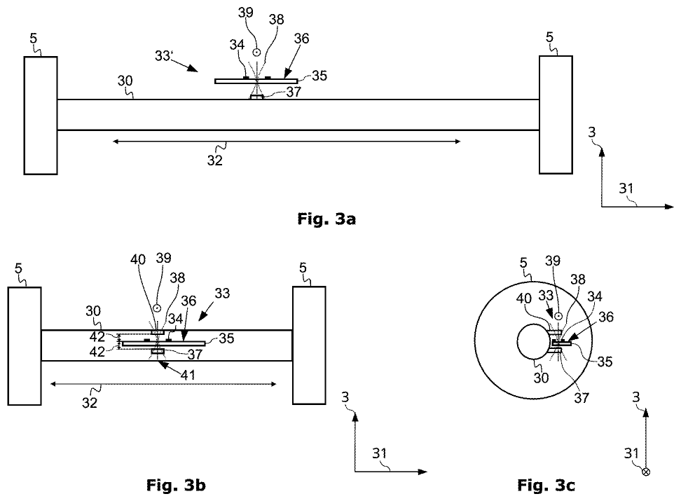

For detecting the relative position 32 described above, position sensors 33 in the form of eddy current sensors are conventionally used. These conventional eddy current sensors are illustrated in FIG. 3a and, for distinguishing the example of an eddy current sensor according to the invention, are designated with reference sign 33′.

Conventional eddy current sensors comprise a first eddy current sensor partner in the form of an excitation coil 34, which will be discussed in more detail at a later point with reference to FIG. 4, arranged on a printed circuit board 35. The printed circuit board 35 is usually fixedly mounted to the chassis 4 of the vehicle and, in addition to the excitation coil 34, also comprises the necessary evaluation circuit 36 in order to convert the sensor signal, which will be described later, into the relative position 32 to be determined. Furthermore, the conventional eddy current sensor 33′ comprises a second eddy current sensor partner arranged movably relative to the excitation coil 34 and thus to the evaluation circuit 36 on the tie rod 30 in the form of an electrically conductive measurement reflector 37, which is also referred to in technical terminology as a target, such that the measurement reflector 37 is positionable relative to the excitation coil on the printed circuit board 35 in the relative position 32 to be detected.

During operation, the excitation coil 34 on the printed circuit board 35 is supplied with a high-frequency alternating current from the evaluation circuit 36, whereby an electromagnetic source field 38 is generated. This electromagnetic source field 38 extends over a space into which the measurement reflector 37 enters. If the measurement reflector 37 is within the range of this electromagnetic source field 38, eddy currents are induced therein due to its electrical conductivity. These eddy currents in turn generate an electromagnetic induction field, not further referenced in FIG. 3a, which opposes the electromagnetic source field 38. This electromagnetic induction field carries the information about the relative position 32 to be determined, which can be extracted from the electromagnetic induction field in various ways.

One possibility for extraction consists in directly detecting the feedback effect of the measurement reflector 37 on the excitation coil 34. This measurement principle is referred to as the damping principle. In this case, the feedback effect dependent on the relative position leads to a weakening of the electromagnetic source field 38 by the electromagnetic induction field in the region of the excitation coil 34, whereby the relative position 32 manifests itself in the form of changes in the electrical properties of the excitation coil. The relative position 32 can thus be detected, for example, based on a change in impedance, AC resistance, or phase position of the excitation coil 34. In the damping principle, the electromagnetic source field 38 and the electromagnetic measurement field, which, based on the electromagnetic induction field, carries the information about the relative position 32 to be determined, cannot be observed separately.

An alternative possibility for extracting the relative position 32 to be determined consists in detecting the feedback effect of the measurement reflector 37 by means of at least one receiving coil—not further shown in the figures. This measurement principle is referred to as the transformer principle. In this case, the electromagnetic induction field originating from the measurement reflector 37 and dependent on the relative position 32 induces a voltage in the at least one receiving coil. The relative position 32 can then be determined from characteristic properties of the induced voltage, for example from its amplitude, phase, or frequency response. When using multiple receiving coils, these should expediently be arranged in a defined phase-shifted geometry, for example in a sine and cosine configuration relative to one another. By means of phase-based interpolation of the signals obtained from these phase-shifted receiving coils, the relative position 32 can be determined with high resolution within a geometric grid according to the vernier principle, for example by means of a vernier algorithm, which enables particularly precise and fine-grained detection of the relative position 32. Since, in the transformer principle, the electromagnetic source field 38 and the electromagnetic measurement field, which, based on the electromagnetic induction field, carries the information about the relative position 32 to be determined, act at different locations in the sensor, these two fields can be observed separately.

In a manner known per se, the electromagnetic source field 38 can be described by its magnetic field lines B, not further referenced in FIG. 3a, or alternatively by the curl ∇×B, which characterizes the local vortex structure and thus the distribution of the field in space. For describing the orientation and position of the excitation coil 34 independently of its specific geometric configuration (e.g., flat coil, rod coil, or other winding form), a so-called equivalent current direction vector is introduced, which is designated in FIG. 3a with reference sign 39. This equivalent current direction vector 39 designates the direction along which an electric current would have to flow in order to generate the locally present electromagnetic source field 38 by means of an ideal current-carrying winding. Formally, it results from the curl of the electromagnetic source field 38 according to Ampère's law, which states that ∇×B is a measure of the local current density J that generates the electromagnetic source field 38. In the illustrated case, the equivalent current direction vector 39 corresponds to the direction of the excitation current, not further referenced, flowing through the excitation coil 34. While the electromagnetic source field 38 itself extends concentrically around this current flow, the equivalent current direction vector 39 indicates the underlying current flow direction and thus allows a systematic description of the position and orientation of the excitation coil 34 in space.

In the electromagnetic source field 38 according to FIG. 3a, the printed circuit board 35 is arranged such that the equivalent current direction vector 39 of the excitation coil 34 lies in a local tangential plane with respect to the movement path of the tie rod 30. The tangential plane is a plane which, in the installed state of the vehicle 2, is spanned by the connecting line of the pivot points of the front wheels 5, or in other words by the longitudinal direction of the tie rod 30, i.e. here the transverse direction 31, and a circumferential direction around the connecting line of the pivot points of the front wheels 5. By means of this orientation of the equivalent current direction vector 39, the excitation coil 34 in FIG. 3a is positioned such that the electromagnetic source field 38 in the center of the excitation coil 34 is oriented perpendicular to the tie rod 30.

The evaluation circuit on the printed circuit board 35 detects this change in impedance according to the damping principle or the transformer principle explained above and derives therefrom the relative position 32 of the measurement reflector 37 relative to the excitation coil 34. An evaluation circuit implementing the transformer principle using the vernier principle can be found in DE 10 2022 117 762 A1. Due to this physical coupling, the relative movement of the tie rod 30 with respect to the chassis 4, and thus also the wheel steering angle 10, can be detected by the conventional eddy current sensor 33′.

In practice, however, a problem arises when using the conventional eddy current sensor 33′ at the tie rod 30. Since the tie rod 30 is subject to mechanical loads during operation—primarily due to the load of the chassis 4—it can deform elastically. This deformation leads in particular to bending in the region between the bearing points of the tie rod 30, whereby the position of the measurement reflector 37 shifts slightly, but in a measurement-relevant manner, primarily transverse to the transverse direction 31 and transverse to the driving direction 3, in a height direction of the vehicle 2 not further referenced.

Such transverse displacements of the measurement reflector 37 cause changes in distance between the measurement reflector 37 and the excitation coil 34, which are not due to an actual relative movement of the tie rod 30 in the transverse direction 31, but result from lateral displacements transverse thereto due to the bending explained above. The electromagnetic measurement field carrying the relative position 32 to be detected is thereby influenced asymmetrically, which can lead to a distorted impedance measurement and thus to a measurement error in the determined relative position 32. As a result, an incorrect wheel steering angle 10 is detected, although the tie rod 30 has not changed in the direction of movement.

This effect is particularly critical in the safety-relevant vehicle dynamics control system explained with reference to FIG. 1, in which even small measurement errors can lead to incorrect interventions or inaccurate vehicle guidance. Therefore, the position sensor 33 according to the invention proposes an eddy current sensor that can detect, correct, or prevent such transverse displacements from occurring in the electromagnetic measurement field. This is explained below with reference to FIGS. 3b and 3c.

In order to avoid the transverse displacement errors described above, the position sensor 33 according to the invention comprises an additional correction partner, which is formed as a further reflector and is referred to below as a correction reflector 40. The correction reflector 40 is arranged in a fixed position relative to the measurement reflector 37 on the tie rod 30, enters the electromagnetic source field 38 in the direction of movement 32 in the same manner as the measurement reflector 37, and, by means of likewise induced eddy currents, generates an analogous electromagnetic induction field that is opposed to the electromagnetic induction field of the measurement reflector 37.

Due to the fixed arrangement of the correction reflector 40 relative to the measurement reflector 37, a structural relationship is created that makes it possible to distinguish transverse movements of the excitation coil 34 in the driving direction 3 from relative movements in the transverse direction 31. If the excitation coil 34 moves as a result of a transverse displacement caused by bending, its distance to both reflectors 37 and 40 changes in a characteristic manner. Since the relative geometry of the reflectors with respect to one another is constant, conclusions can be drawn from the different effects of the electromagnetic source field 38 on the two reflectors as to the actual cause of the field change. In particular, it can thus be recognized whether the change is due to an intended movement in the transverse direction 31 or to an undesired transverse movement in the driving direction 3. This results in a separation of the measured variables, which forms the basis for reliable compensation or error detection.

This idea is not to be understood as being limited to the provision of exactly two reflectors 37, 40. Rather, it is essential that an additional correction partner is integrated into the electromagnetic source field 38, which is arranged in a fixed position at a predetermined distance relative to one of the two eddy current sensor partners 34, 37—i.e., either relative to the excitation coil 34 or to the measurement reflector 37. By means of this defined geometric coupling, it is ensured that a transverse displacement of the other eddy current sensor partner 37, 34, in particular in the driving direction 3, causes a characteristic change in the field distribution, which can be detected and/or suppressed by suitable evaluation.

The correction partner may be implemented either as the correction reflector 40 or as an additional excitation coil or as any electromagnetically effective element. The decisive factor is merely that its fixed relationship to one of the eddy current sensor partners 34, 37 forms a structural reference on the basis of which field-effective changes caused by transverse movements can be clearly identified or compensated. The invention thus allows a generic and flexible design of the position sensor 33 in the form of the eddy current sensor, which can be adapted both mechanically and in terms of signal processing depending on requirements and installation conditions.

In the present embodiment, the two reflectors 37, 40 are arranged at the same position 41 in the transverse direction 31 on the tie rod 30. In contrast to the conventional eddy current sensor 33′, in which the printed circuit board 35 with the excitation coil 34 is arranged in a tangential plane relative to the tie rod 30, the printed circuit board 35 with the excitation coil 34 in the embodiment according to FIG. 3b is now positioned in a radial plane relative to the tie rod 30. The radial plane is a plane which, in the installed state of the vehicle 2, is spanned by the connecting line of the pivot points of the front wheels 5, or in other words by the longitudinal direction of the tie rod 30, i.e. here the transverse direction 31, and a radial direction directed away from this connecting line of the pivot points of the front wheels 5. In simplified terms, the printed circuit board 35 with the excitation coil 34 in the conventional eddy current sensor 33′ is oriented tangentially to the tie rod 30, whereas in the position sensor 33 according to the invention it is oriented radially to the tie rod 30.

In the position sensor 33 according to the invention, the equivalent current direction vector 39 of the excitation coil 34 thus extends in the radial plane, which means that the magnetic field lines B in the center of the excitation coil 34 are now oriented tangentially to the tie rod 30. In this embodiment, the two reflectors 37 and 40 are arranged with an equal reflector distance 42 on opposite sides of the printed circuit board 35. They are essentially identical in terms of material and geometry and contribute to field symmetry and measurement stability due to their symmetrical arrangement.

In the event of a transverse displacement of the tie rod 30, for example as a result of the elastic bending mentioned above under driving load, the distances 42 of the two reflectors 37 and 40 from the excitation coil 34 do not change in the same direction, but rather in opposite directions. Since the reflectors 37 and 40 are arranged at a common position 41 in the transverse direction 31, are of identical design with respect to one another, and are positioned at equal reflector distance 42 on opposite sides of the printed circuit board 35 oriented perpendicular to the tie rod 30, a transverse movement of the tie rod 30 perpendicular to the transverse direction 31 affects the electromagnetic coupling of both reflectors 37 and 40 to the excitation coil 34 in opposite ways.

If the measurement reflector 37 moves closer to the excitation coil 34 as a result of deformation of the tie rod, the correction reflector 40 moves away by the same amount—and vice versa. Both reflectors 37, 40 each generate an electromagnetic induction field dependent on their position in the region of the source field 38, wherein the electromagnetic induction field generated by the correction reflector 40 is directed opposite to that of the measurement reflector 37.

As a result of this opposing arrangement, the following structured self-compensation is achieved: the changes in the induction fields caused by a transverse movement act in a mutually compensating manner on the resulting electromagnetic measurement field. The electromagnetic measurement field corrected in this way can subsequently be evaluated by means of one of the known eddy current measurement principles—either by detecting the change in impedance of the excitation coil (damping principle) or via a voltage induced by the electromagnetic measurement field in a receiving coil (transformer principle)—in order to determine the relative position in the transverse direction 31 corrected for transverse displacement.

A separate differential signal processing or a further modification of the evaluation circuit 36 of the conventional eddy current sensor 33′ is not required for this purpose.

### REFERENCE SIGNS LIST

2 Vehicle
3 Driving direction
4 Chassis (vehicle frame)
5 Front wheels
6 Rear wheels
7 Steering wheel
8 Steering angle
9 Steering gear
10 Wheel steering angle
11 Brake
12 Wheel speed sensor
13 Wheel speed
14 Control unit
16 Inertial data
18 Inertial sensor
20 Control signal
22 Actuator
24 Actuator signal
26 Steering column
28 Rotational axis of the steering column
30 Tie rod (steering rod)
31 Transverse direction (perpendicular to the driving direction)
32 Relative position
33 Position sensor (eddy current sensor according to the invention)
33′ Conventional eddy current sensor
34 Excitation coil
35 Printed circuit board
36 Evaluation circuit
37 Measurement reflector
38 Electromagnetic source field
39 Equivalent current direction vector (∇×B)
40 Correction reflector
41 Position of the reflectors in the transverse direction
42 Reflector distance from the excitation coil

1. An eddy current sensor (33) for detecting a relative position (32) in a direction of movement, comprising
a first eddy current sensor partner (34, 37) and a second eddy current sensor partner (37, 34) that is positionable relative to the first eddy current sensor partner in the relative position (32) to be detected,
wherein the eddy current sensor partners are configured to generate an electromagnetic measurement field dependent on the relative position, and
an evaluation circuit (36) configured to determine the relative position (32) based on the electromagnetic measurement field,
wherein one of the eddy current sensor partners (34, 37) is configured to generate the electromagnetic measurement field and the other eddy current sensor partner (37, 34) is configured to generate an electromagnetic induction field based on the electromagnetic measurement field, and
wherein the eddy current sensor partner generating the electromagnetic induction field has, in a transverse direction perpendicular to the direction of movement and perpendicular to a distance between the eddy current sensor partners, a smaller extent than the eddy current sensor partner generating the electromagnetic measurement field, characterized by
a correction partner (40) arranged in a fixed position relative to the first eddy current sensor partner at a predetermined distance for generating an electromagnetic correction field for correcting a transverse displacement between the eddy current sensor partners transverse to the direction of movement (31).

2. The eddy current sensor according to claim 1, wherein the first eddy current sensor partner comprises a reflector (37) and the second eddy current sensor partner comprises an excitation coil (34) for generating an electromagnetic source field (38), wherein the reflector (37) is configured to generate, based on the electromagnetic source field (38), an electromagnetic induction field contained in the electromagnetic measurement field.

3. The eddy current sensor according to claim 2, wherein the correction partner is a reflector (40) and is configured to generate an electromagnetic induction field that is directed opposite to the electromagnetic induction field of the first eddy current sensor partner (37).

4. The eddy current sensor according to claim 2, wherein the excitation coil (34) is designed as a flat coil extending in a coil plane defined by the direction of movement, wherein the coil plane is preferably perpendicular to an imaginary connecting line between the first eddy current sensor partner (37) and the correction partner (40).

5. The eddy current sensor according to claim 1, wherein the second eddy current sensor partner divides a space into a first half-space and a second half-space opposite the first half-space, and wherein the first eddy current sensor partner (37) is arranged in the first half-space and the correction partner (40) is arranged in the second half-space, preferably at the same position (41) when viewed in the direction of movement and/or transverse to the direction of movement (31).

6. The eddy current sensor according to claim 5, wherein the first eddy current sensor partner (37) in the first half-space and the correction partner (40) are of identical design.

7. A tie rod sensor for detecting a position of a tie rod (30) of a vehicle (2) in a transverse direction (31) perpendicular to the driving direction (3), comprising the eddy current sensor (33) according to claim 1, wherein one eddy current sensor partner is connectable in a fixed manner to a chassis (4) of the vehicle (2) and the other eddy current sensor partner is connectable in a fixed manner to the tie rod (30) of the vehicle.

8. The tie rod sensor according to claim 7, wherein the electromagnetic source field (38) has a magnetic flux density whose equivalent current direction vector (39) is arranged in a plane oriented radially with respect to the direction of movement (31).

9. A method for detecting a relative position (32) in a direction of movement using an eddy current sensor (33) according to claim 1, the method comprising:
generating an electromagnetic source field (38) with one of the eddy current sensor partners (34, 37); and
generating an electromagnetic measurement field comprising an electromagnetic induction field generated based on the electromagnetic source field (38) with the other eddy current sensor partner (37, 34);
wherein generating an electromagnetic correction field with the correction partner (40) for correcting a transverse displacement in the driving direction (3) between the eddy current sensor partners transverse to the direction of movement (31); and
determining the relative position (32) based on the electromagnetic measurement field and the electromagnetic correction field.

10. A control device for carrying out the method according to claim 9.
